(19) United States
(12) Patent Application Publication
(10) Pub. No.: US 2014/0278891 A1
(43) Pub. Date: Sep. 18, 2014

(54) RETAIL RESIDUAL BENEFIT PROGRAM

(71) Applicants: Edwin Michael Gyde Heaven, North Vancouver (CA); Sean Thomas Hinton, Vancouver (CA); Zoran Kovacevic, Vancouver (CA); Grant Alexander Poje, North Vancouver (CA); Spencer Gilles Massie, Vancouver (CA)

(72) Inventors: Edwin Michael Gyde Heaven, North Vancouver (CA); Sean Thomas Hinton, Vancouver (CA); Zoran Kovacevic, Vancouver (CA); Grant Alexander Poje, North Vancouver (CA); Spencer Gilles Massie, Vancouver (CA)

(21) Appl. No.: 14/213,922

(22) Filed: Mar. 14, 2014

Related U.S. Application Data
(60) Provisional application No. 61/798,311, filed on Mar. 15, 2013.

(51) Int. Cl. G06Q 30/02

(52) U.S. Cl. CPC G06Q 30/0226
USPC 705/14.27

(57) ABSTRACT

A residual benefit program where recipients of non-consumable goods receive a good with benefits, can recycle that good for benefits, and redeem the benefits at some point in the future. The program accumulates credits for a beneficiary elected by a primary purchaser. Credits may accumulate due to purchase of a product, recycling of a product, or via interest over time. Upon redemption of the accumulated credits, the beneficiary receives the reward chosen by the primary purchaser. The reward or the redeemer who provides the reward is set by the primary purchaser for the beneficiary and may be modified over time.

### CROSS REFERENCE TO RELATED APPLICATIONS

This application claims the benefit of U.S. Provisional Patent Application Ser. No. 61/798,311, filed on Mar. 15, 2013, entitled “RETAIL RESIDUAL BENEFIT PROGRAM (“RPB”),” which is hereby incorporated by reference in its entirety.

### BACKGROUND

1. Field of the Invention

The present invention relates generally to a system or process for the retail sector in consumable or non-consumable goods. More particularly, the present invention relates to a system or process for all consumable or non-consumable retail products purchased by a primary consumer for an intended recipient, typically children, with the intention of creating multiple residual benefits utilizing the time value of money concept in a rewards system.

2. Description of the Related Art

In the retail sector today, manufacturer or retailer loyalty programs exist that link the manufacturers or retailers directly to the primary purchaser. Primary purchasers are typically required to establish some form of account with the manufacturer or retailer and a physical item, such as a membership card or “buy ten get one free” card, is exchanged between the manufacturer retailer and the purchaser. Today, loyalty programs are only available to purchasers of goods and services, and therefore predominantly adults. Conversely, no such program exists for children. Children would benefit greatly from a benefit program that could serve them in their futures, while enjoying the non-consumable goods purchased for them today. Such a program would add value to the purchasing process for consumers wanting to extract more value from purchases for children.

Today, the residual value of used, non-consumable children's products can only be stated in monetary terms, in very unique cases, this residual value may be used for the exchange of other goods but oftentimes is not stated at all and the products become forgotten and eventually end up as waste. Examples of such products include coins, comic books, trading cards, etc., that may gain value over time. However, these are specialized goods that are purchased as collectibles and not common non-consumable products (e.g., toys, clothes, DVDs, etc.). Typically, children's retail products are at sonic point forgotten, and end up in landfills as there is currently no residual value for these common children's goods.

Recycling of children's non-consumables is today considered a charitable act. However, it would be desirable to continuously provide incentives for ensuring that not only are non-consumables recycled, but those who recycle them are encouraged to do so. In such a case, the original recipient, the recycler and the secondary receiver of the product would all benefit.

### SUMMARY

The present invention is related to a system and process for providing a residual benefit program. The present invention introduces a residual benefit program where primary customers (e.g., adults) purchase consumable or non-consumable goods or services for recipients (e.g., children) and a portion of the purchase price is allocated to a benefit program. The benefit program may be offered by manufacturers and/or retailers. In one embodiment, a physical identifier on the products or goods or its tags or packaging will inform the primary purchaser that the product is part of the residual benefit program. Once the purchase is made, purchasers will be provided with details to visit a secondary source of information (e.g., a website, a smartphone application, etc.) and enter information corresponding to the purchase, for example, information that is listed on the receipt. Purchasers will be able to select a benefit or reward from a group of possible options and credit (e.g., in the form of credits, dollars, or any other form of savings, such as material) will become available for redemption. For example, these credits may be applied to various activities or redeemers, such as education, training, sports, hobby clubs, movies, amusement/waterparks, shopping malls, financial savings, electronics, toys, clothes, etc.

Once the product has been received by a recipient, the product will be used until the benefit to the recipient is diminished and the recipient no longer wishes to keep the product. At this point, the purchaser or receiver will have the opportunity to bring the product hack to approved locations for further reward in the form of credits or gift cards, coupons, money, etc., thus introducing the concept of residual benefits for these purchases. Recycling centers will be responsible for redeploying the products to charitable organizations, people in need, international aid organizations, etc.

As residual benefit purchases collect for the recipient over years of activity, and grow in value using the time value of money, the recipient becomes prepared to redeem their credits, money, products, savings, etc. The residual benefit system provides the primary consumer, the recipient, the secondary recipient and the redeemer providing the rewards with benefits throughout the entire life of a given product and beyond.

In one embodiment, a method of providing a residual benefit for a purchase may include determining an account for receiving the residual benefit, receiving a code associated with the purchase, depositing a first credit in the account based upon the receipt of the code, depositing a second credit in the account based on an investment of the first credit, determining a redeemer to provide the residual benefit, and transferring the first credit and the second credit to the redeemer for the provision of the residual benefit.

In another embodiment, a residual rewards program system may include a memory configured to store at least one user account, and a processor coupled with the memory. The processor may be configured to determine one of the at least one user accounts for receiving a residual benefit, receive a code associated with a purchase, deposit a first credit in the determined user account based upon the receipt of the code, deposit a second credit in the determined user account based on an investment of the first credit, determine a redeemer to provide the residual benefit, and transfer the first credit and the second credit to the redeemer for the provision of the residual benefit.

In still another embodiment, a method of providing a residual benefit to a beneficiary may include establishing an account for the beneficiary, depositing an amount of credits in the account for the beneficiary based upon a purchase from a participating partner, providing a plurality of redeemers to be selected amongst by the beneficiary when the beneficiary chooses to redeem at least a portion of the amount of credits in the account, determining a selected redeemer from the plurality of redeemers for redemption of at least a portion of the amount of credits in the account, and transferring the at least a portion of the amount of credits in the account to the selected redeemer.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1 shows a block diagram of a system incorporating a residual benefit program according to an embodiment of the present invention;

FIG. 2 shows a flowchart describing the process of a residual benefit program according to an embodiment of the present invention;

FIG. 3 shows a flowchart describing the process of credit redemption of a residual benefit program according to an embodiment of the present invention;

FIG. 4 shows a block diagram describing the process of credit acquisition of a residual benefit program according to an embodiment of the present invention; and

FIG. 5 shows a flowchart describing pre-maturity and post-maturity operation of a residual benefit program according to an embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Turning first to FIG. 1, a block diagram of a system 100 is shown that incorporates a residual benefit program. The system 100 includes a benefit program server 105 and a plurality of end user systems or devices (110, 115, 120). The benefit program server 105 includes a processor 150 connected with a memory 160. In an alternative embodiment, the server 105 may comprise a plurality of distributed servers or computer systems. The memory 160 includes a database 170 for the storing and/or relating of various data (e.g., beneficiary, number of credits accumulated, chosen reward, etc.), as discussed in further detail herein. The processor 150 is configured to interface with the memory 160 (e.g., access the database 170 and execute software commends of the residual benefit program). The end user devices (110, 115, 120) may be desktop computers, retail or manufacturer computer systems or servers, mobile devices (such as smart phones or tablets), or any other type of electronic device or system that is capable of transmitting and/or receiving data from the benefit program server 105. Although a plurality of end user devices (110, 115, 120) are shown by FIG. 1, in an alternative embodiment, any number of end user devices (i.e., one or more end user devices) may be used.

Turning next to FIG. 2, a flowchart 200 describing the process of a residual benefit program is shown. The process of the residual benefit program described by the flowchart 200 may be the same or similar to a process of the residual benefit program incorporated by the system 100 of FIG. 1. The flowchart 200 describes a process that allows a manufacturer of goods to offer credit redemption to purchasers or consumers of one or more products (e.g., consumable goods and/or non-consumable goods) offered for sale to those purchasers or consumers, as discussed in greater detail below. In an alternative embodiment, the manufacturer may be a retailer or any other supplier of goods and/or services. For example, instead of a manufacturer of goods, one embodiment may include a retailer, such as Wal-Mart, Target, etc., opt into the residual benefit program and appropriately mark, brand, or otherwise indicate the products sold within its retail establishments or online participate in such a program, even if the retailer does not themselves manufacture the products being sold. Indeed, any of a variety of businesses or entities, not only manufacturers or retailers, could participate in the residual benefit program as discussed in greater detail herein, including financial institutions, mail-order catalog providers, email or online-based distributors, etc.

Initially, at step 205, the manufacturer of goods adopts the residual benefit program. At step 210, the manufacturer provides its products to retailers, for example via physical shipment of goods from the manufacturer to the retail location. In an alternative embodiment, if the goods produced by the manufacturer are electronic or digital in nature, shipment of the goods to the retail location or to a customer may be made by electronic transmission. In still another embodiment, for example when the manufacturer is instead or additionally a retailer or other supplier of goods and/or services, the provision of the products or services may be made directly to consumers (e.g., via Internet ordering, mail-order catalogs, electronic mail offers for sale, etc.) without requiring shipment to any separate retail location.

At step 215, the product provided or otherwise produced by the manufacturer is purchased by the primary purchaser or consumer. As described above, this may occur via physical purchase within a retail establishment, virtual purchase via a webpage or other Internet or network-based form, or by any of a variety of purchase method. At step 220, the primary purchaser assigns or establishes a beneficiary for the residual benefit program that corresponds to the purchase made in step 215. The establishment of the beneficiary may be accomplished through the use of a web-based form or other application-based interface. The beneficiary may be the primary purchaser themselves, or may be an alternative individual or entity (e.g., a child or other friend or relative).

The establishment of the beneficiary may be by the creation or selection of an account on a server (e.g., stored in a database, such as database 170 of FIG. 1, or otherwise in a memory of a computer system, such as memory 160 of FIG. 1). This account may have an identifier associated with it (e.g., a unique number or other identifying ID) such that the beneficiary account may be selected for benefits many different times and/or by different people for a variety of purchases. As described in greater detail herein, the chosen beneficiary will accrue credits because of the purchase by the primary purchaser that can be redeemed for other goods and/or services at a future date. At step 225, the purchased product is provided to the primary purchaser for the primary purchaser to use as desired (e.g., personal use by the primary purchaser, gifting the product to the chosen beneficiary or a third party, etc.).

At step 230, the primary purchaser is free or able to use the purchased product until the perceived value of the purchased product is fully realized or until the purchased product reaches the end of its life cycle. The time for such use may span any amount of time (e.g., days, months, years, etc.) and may be different for various types of purchased products or for different purchasers or users. For example, the primary purchaser may purchase an item as a gift for a family member, friend, child, etc. and provide the purchased item to such family member, friend, child, etc. for their use. The beneficiary assigned or elected in step 220 may he the same as the intended user of the purchased item or may be different.

At step 235, once the perceived value of the purchased product is fully realized or it has reached the end of its life cycle, the purchased product is returned (e.g., sent by the primary purchaser or user) to an approved residual benefit program recycling center. In an alternative embodiment, the manufacturer of the product or a third party organization, such as the approved residual benefit program recycling center, may be responsible for picking up the purchased product to facilitate its return. The recycling center may be a manufacturer, retailer, municipal recycling center, charitable organization, etc.

At step 240, after the purchased product is received at the recycling center, the returned purchased product is refurbished, re-used, or otherwise redeployed for use by a secondary recipient or purchaser. For example, if the purchased product is a cell phone, the cell phone may be provided to a new recipient, a new cell phone may be made from one or more parts, components or materials of the recycled cell phone, or one or more of the parts, components or materials of the recycled cell phone may be used for one or more alternative products. Not only can such recycling save material or other costs for manufacturers, but it also helps prevent or reduce environmental waste by limiting the number of products or product components that are transported and dumped into landfills.

At step 245, the beneficiary elected or assigned in step 220 is able or allowed to redeem one or more credits accumulated from purchasing and/or recycling the purchased product based on a reward chosen by the primary purchaser. In one embodiment, one or more credits may be accumulated upon the original purchase of the product from the manufacturer in step 215. In an alternative embodiment, one or more credits may additionally or alternatively accumulate due to recycling the purchased product in step 235. Thus, the acquisition of credits may be used to encourage the primary purchaser to purchase a product from a particular manufacturer that participates in the residual benefit program and/or to help prevent or reduce environmental waste by recycling the product rather than throwing it in the garbage when no longer desired. The redemption of credits allows the beneficiary established in step 220 to be eligible for one or more rewards selected by the primary purchaser that are paid for by the accumulated credits, as discussed in greater detail herein.

Thus, in one example, manufacturers and/or suppliers of children's, non-consumable goods can choose to participate in a residual benefits program. One or more of the manufacturer's products may be branded with a logo or other indicator to identify that, if purchased, the product or products participate in the residual benefit program. Purchasers of these residual benefit program branded products will be provided details either within the product instructions (e.g., via a pamphlet packaged within the product packaging, via text or images printed or coupled to the product packaging), by retailers, or through web-based media highlighting instructions or other specifics regarding the residual benefit program. In certain embodiments, purchasers or potential purchasers of the products will be able to enroll in the residual benefit program with a free account. For example, enrollment and/or subsequent access to the account may be performed by a web-based access form or via a smartphone or tablet application.

Once enrolled, purchasers will be able to determine one or more benefit recipients to whom rewards shall be provided with accumulated credits. Each residual benefit program branded product may have a unique identifier that will allow purchasers to enter the unique identifier into their accounts (e.g., via accessing a benefit program server with a web-based form or other software application), select a benefit recipient, and choose one or more rewards. Thus, one premise of the residual benefit program focuses on gifts from a primary purchaser (e.g., an adult) to children and the ability for rewards to accrue to those children separate from the purchased product that may be monetary in nature and can grow in value over time. Rewards may be established in a variety of categories; however, such categories are not limited to any particular product or service. The reward categories may be predetermined for the residual benefit program, for example, based on their value to benefit recipients and the general applicability of the reward to the spirit of the program.

Reward categories can be, but are not limited to, education, athletics, music, financial, entertainment, charitable, electronics, travel, technology, food, toys, clothing, etc. Once the recipient receives the purchased product (e.g., a non-consumable good) he/she will use the product until such time as it's real or perceived value has diminished. Traditionally, these products are either stored or given to a secondary recipient through charities or second-hand giving, or are otherwise disposed of in the residual benefit program, these products will be accepted by assigned recycling facilities for further credit accumulation.

Participants involved in recycling their products will have the option to assign rewards to a recipient or beneficiary of their choosing. Once recycled, products (if usable) will be redeployed to secondary recipients through charitable contribution, or (if unusable), may be destroyed in a responsible, environmentally-friendly manner. As a recipient's account begins to grow over time with the contribution of several purchases to their accounts and/or with recycling of products per the residual benefit program, they (or their parents/guardians if under legal age of majority) will have the option of redeeming their benefits at some point in the future. For example, they may choose to utilize their rewards in the short term for assistance with clothing purchases, text books, tutoring, etc., or in the future with post-secondary education, financial savings tools, housing, etc.

In still other embodiments, a scholarship fund may be established to encourage participation in the residual benefit program. For example, money or credits may be paid into a separate fund or account (e.g., by a manager of the residual benefit program, by scholarship investors, by retail partners, etc.). This scholarship fund grows in size due to the contributions and/or due to investment of the fund in an interest-bearing scheme. All or a portion of the scholarship fund may then be distributed to one or more beneficiary accounts, for example, selected on a random basis. In this fashion, participation in the program by establishing a beneficiary account and/or by maintaining a predetermined amount of credits in the beneficiary account may enter a beneficiary account into the running for the randomized scholarship fund payout.

Turning next to FIG. 3, a flowchart 300 describing the process of credit redemption as part of a residual benefit program is shown. Certain aspects of the residual benefit program described by the flowchart 300 may be the same or similar to aspects of the residual benefit program previously discussed in FIGS. 1 and/or 2. The flowchart 300 describes a process that allows redemption of credits obtained via purchase and/or recycling of products that have been made a part of the residual benefit program.

At step 305, a redeemer defines the credits available for redemption by a beneficiary (e.g., the beneficiary established in step 220 of FIG. 2). At step 310, a manufacturer/retailer (e.g., the manufacturer of step 205 of FIG. 2) chooses, defines, or elects from possible redeemers that are available or that wish to participate in the residual benefit program. In one embodiment, the manufacturer/retailer may choose, define, or elect different redeemers to be available for different products. In an alternative embodiment, every redeemer that has agreed to be a part of the program by making credits available for redemption may be available to every product offered by the manufacturer/retailer. At step 315, a primary purchaser, such as a parent or grandparent for a child, buys the product offered by the manufacturer/retailer that has been made a part of the residual benefit program, the same or similar to step 215 of FIG. 2. At step 320, the primary purchaser defines the beneficiary desired for the purchase of the product, the same or similar to step 220 of FIG. 2. As previously discussed, this beneficiary may be the primary purchaser themselves, the individual or entity to whom the primary purchaser intends to gift the purchased product, or any other individual or entity as desired.

At step 325, the primary purchaser selects or chooses a redeemer for the credits obtained from the purchase of the product. For example, if the primary purchaser is a grandparent who purchases an educational book for their grandson, the primary purchaser may choose the beneficiary to be the grandson and may choose a redeemer from the “educational” category of rewards, such tuition payments to be redeemed at a participating university. At step 330, the credits obtained due to the purchase or otherwise accumulated for the purchase (e.g., due to additional accumulation of credits resulting from interest over time or from recycling of the product) are deposited into the beneficiary's account. These credits may be made by way of the manufacturer/retailer depositing a contribution corresponding to the purchase by the primary purchaser.

For example, this contribution could be made by grossing up the price of the product purchased by the primary purchaser by the contribution amount. These credits may then be redeemed by the beneficiary for the reward chosen by the primary purchaser via the redeemer selected in step 325. In certain embodiments, the redeemer and/or reward offered by the redeemer may be a permanent election, made once by the primary purchaser and unable to be changed or modified. In an alternative embodiment, the redeemer and/or reward may be modified as desired by the primary purchaser. In such embodiments, the modification may cost a portion of the credits accumulated or may be changed freely.

The redeemers chosen by the manufacturer/retailer in step 310 may define the amount of credits available based on the price of the residual benefit program branded product and make these credits available to a manufacturer/retailer who can then select from the list of redeemers and make the desired redeemer available for certain products (for example, engineering-based educational credits associated with a mechanical erector kit, medical-based educational credits associated with a doctor kit, fitness credits associated with rowing equipment, etc.). Parents/Grandparents can then choose the redeemer of credits in step 325 that they wish to give to the beneficiary defined in step 320 in line with their preferences and the messages they are trying to convey to the beneficiary (e.g., educational, fitness, health).

For example, one embodiment of the invention includes a parent or grandparent purchasing a residual benefit program branded toy and gifting it to a child along with a card that indicates the benefits are being allocated to post-secondary education. Tuition credits accumulate in the child's account, grow with interest, and can be redeemed at a participating post-secondary institution attracting the prospective student to the institution. The credits would be subsidized by the institution in order to attract the student thereby lessening the burden on the manufacturer of the residual benefit program branded toy.

In another example, one embodiment of the invention includes a parent or grandparent purchasing a residual benefit program branded toy and gifting it to a child along with a card that indicates the benefits are being allocated to physical fitness. Fitness credits accumulate in the child's account which can be redeemed at participating gyms or fitness centers attracting the prospective athlete to the provider. The credits would be subsidized by the provider in order to attract the athlete thereby lessening the burden on the manufacturer of the residual benefit program branded toy.

Residual benefit program branded products may accumulate non-monetary credits which grow over time and can be used to offset the cost of goods or services from any one of the reward categories including, but are not limited to: education, athletics, music, financial, entertainment, charitable, electronics, travel, technology, food, toys, clothing, etc. In addition to the growth of the credits due to the time value of money, the recycling of residual benefit program branded products will also accumulate additional credits in the beneficiary's account.

FIG. 4 shows a block diagram 400 describing the process of credit acquisition of a residual benefit program. Certain aspects of the residual benefit program credit acquisition in block diagram 400 may be the same or similar to aspects of the residual benefit program previously discussed in FIGS. 1, 2 and/or 3. Credits available for redemption 445 by a beneficiary may accumulate from a variety of sources. For example, purchase credits 405 may be awarded upon the initial purchase of a product or service that is branded or otherwise incorporated into the residual benefit program. Recycle credits 415 may be awarded upon the proper recycling of the product or service per the terms of the residual benefit program and added 410 to the purchase credits 405. As the purchase credits 405 and/or the recycle credits 415 sit in the account of the beneficiary, interest 425 will accrue over time 435 to further add (420, 430) to the number of accumulated credits. The combination of all of these elements (405, 415, 425, 435) results 440 in the credits available for redemption 445 by the beneficiary at any given point in time. Thus, the credits available for redemption 445 deposited in the beneficiary's account may grow at compound rates over the years held based on the interest, time and value of the credits from the original purchase as well as any recycle credits received.

Thus, in one example, utilizing the time value of money, rewards will be larger upon redemption than they were upon receipt of the original benefit. The residual benefit program facilitates the reward-management and redemption process and can either create and manage the reward, or choose to manage the reward with a third party. For example, one or more banks or other financial institutions may choose to partner or become involved in the residual benefit program and participate in the management or payment of the reward (e.g., redeem credits for monetary amounts within a checking or savings account with such bank or financial institution).

FIG. 5 shows a flowchart 500 describing pre-maturity and post-maturity operation of a residual benefit program. The residual benefit program may include features and/or operation that are the same as or similar to those previously discussed. The flowchart 500 identifies two time periods for the transaction process of the residual benefit program: a pre-maturity period 502 and a post-maturity period 504. Initially, in the pre-maturity period 502, a participant 510 in the program registers a beneficiary (such as a child) in the program by creating a beneficiary account and receives a unique identifier the corresponds to the beneficiary account. This unique identifier can then be used for subsequent purchases by the participant 510 or shared with others who may also correlate purchases with the beneficiary account, as discussed in greater detail below.

The participant 510 purchases 515 a branded gift that has been offered by a retailer, manufacturer, or other provider of goods 520 who has elected to offer goods as part of the residual benefit program. The retailer, manufacturer, or other provider accepts payment for the product and supplies 525 the branded gift to the participant 510. The branded gift includes a unique code or other identifier for use with the residual benefit program. The Participant or beneficiary may then enter 535 the code to the residual benefit program database 540 (e.g., via a webpage or other software application), link the code to the desired beneficiary account, and choose the desired Post-Maturity category (e.g., education, automobile, travel, fitness, etc.) to associate with the code.

A premium or contribution is paid or deposited 545 by the retailer, manufacturer, or other provider of the purchased product to the beneficiary account. The collective sum of all such contributions or premiums for all beneficiary accounts as part of the residual benefit program is invested 550 by the manager of the residual benefit program (e.g., at a high rate of return), with the investment returns/interest being added to each beneficiary account in proportion to their overall share. Thus, each beneficiary account accumulates over years of additional purchases and compound interest. In addition, as previously discussed, additional funds may be deposited into the beneficiary account for participation in recycling activity.

In one embodiment, a beneficiary account may be primed with early cash contributions from a participant 510 to take advantage of the long-term compounding effect of investment. Moreover, in another embodiment, a separate lottery fund may additionally be provided wherein a portion (e.g., half) of the accumulated total of the lottery fund would be taken and divided among a random selection of a certain percentage of the registered beneficiaries while the remainder of the lottery fund continues to be invested. Such a lottery fund may provide additional incentive for individuals to participate in the residual benefit program.

In the post-maturity period 504, the accumulated funds within the beneficiary account may be directed (e.g., once the beneficiary 565 who owns the beneficiary account reaches the age of majority) to one or more post-maturity partners 560 that are chosen 570 by the beneficiary as desired. These post-maturity partners 560 may be any of a variety of companies or service providers that have elected to participate in the residual benefit program and agree to provide certain goods and/or services for payment or reimbursement 555 from the beneficiary accounts (e.g., at a discounted price from regular market or retail cost).

For example, a transaction from a beneficiary's perspective is seen as follows. A beneficiary is enrolled in the program by a sponsor. The beneficiary receives gifts (e.g., purchased by the sponsor) that are branded for the residual benefit program, for example, by way of a unique identifier or code that is included with or on the gift. This identifier or code may be entered into the residual benefit program system, such as via a webpage, either by the beneficiary themselves upon receiving the gift or via a third party such as the original purchaser of the gift). The individual entering the identifier or code may also interface with the residual benefit program system to choose the benefit category that they would like the purchase to be applied to. When the Beneficiary is ready to use the funds that have been accumulating in their account (see above), they may log into their account to check the balance and select a desired post-maturity partner to transfer funds to. The balance owed, if higher than the amount in the beneficiary account, may be paid to the post-maturity partner by other means, such as, cash, credit or bank financing, PayPal, etc.

Similarly, an example of a transaction from the perspective of a retailer, manufacturer, or other provider of goods or services (“retail partner”) that participates in the program is seen as follows. The retail partner pays an annual fee to be part of the residual benefit program. The retail partner chooses which products to include in the program. The manager of the residual benefit program may work with the retailer partner to brand qualifying products as program eligible. At the point of purchase, the item is bought like any other normal product purchase. Subsequently, qualification of the purchased product occurs via the customer's interfacing with the residual benefit program system (e.g., via a user interface on a website or other software application). When the product is qualified through this registration process, the transaction is recorded within the residual benefit program system and the retail partner may be invoiced a predetermined percentage (e.g., 5.5%) of the value of the gift purchase. This invoicing is used to apply the credits to the assigned beneficiary account, as previously discussed. The residual program benefit program system may handle tracking of client information and/or transferring of funds into or out of beneficiary accounts, thereby minimizing the effort on behalf of the retail partner.

The retail partner may also choose whether they wish to additionally participate as one of the post-maturity partners that offer goods and/or services to beneficiaries for payment out of the beneficiary account. For example, a retail partner that chooses to also participate as a post-maturity partner will benefit not only from an initial purchase of the retail partner's product for the beneficiary, but also from future credit redemptions. In certain embodiments, a retail partner may be restricted from being the only post-maturity partner available to a beneficiary.

Likewise, an example of a transaction from a post-maturity partner's perspective is seen as follows. The post-maturity partner pays an annual fee to be part of the program (e.g., $100,000 per million beneficiaries that have accounts on the residual benefit program system). In another embodiment, rather than paying an annual fee, a post-maturity partner may donate the benefits that the retail partner offers with the product purchased. For example, the post-maturity partner may offer tuition credits to the retail partner who, if selected, would be deposited in the beneficiaries account and grow with interest until such time as they are redeemed by the beneficiary in the form of a tuition credit. This may reduce the cost burden on the retail partner and not cost the post-maturity partner anything unless the beneficiary chooses to attend their institution.

A post-maturity partner offers credits to beneficiaries who wish to use their accumulated credits at the post-maturity partner's institution. In one embodiment, the value of the credit is equal to the number of credits in the beneficiary account in dollars. A post-maturity partner may receive credits from beneficiary accounts by directly linking a beneficiary account to the post-maturity partner's account (e.g., the same or similar to adding the post-maturity partner to a beneficiary's online banking program and transferring the funds).

An exemplary transaction seen from the perspective of a recycling partner may be described as follows. The recycling partner would choose to participate in the residual benefit program partner with a recognized charity. Owners of qualifying products (e.g., products previously agreed upon by retailers, manufacturers, recycling partners, etc.) would be encouraged to recycle those products through the recycling partner in consideration for a credit or contribution to their residual benefit program account. For example, if 20% of products purchased qualify for such recycling after 5 years, and the depreciated value of this is 30% of original cost, then the residual benefit program account credit for those products in year 1 may be $3.60. Thus, if regular recycling in this fashion occurs, the total contribution for the residual benefit program account (without compounding), may be $63.77.

Finally, an example of a transaction from the perspective of the residual benefit program organization or manager of such program may be as follows. The organization solicits investment to develop, promote, establish and run the program. This takes the form of initial investment and continuing investment each year. The organization takes a primary commission from each purchase made in a beneficiary's name and also receives a share of the investment returns from the collective beneficiary accounts, described in greater detail above. In order to promote post-maturity partner products and/or services, the organization may require an annual premium be paid by each post-maturity partner participating in the program. Investors in the organization are paid back from these fee sources. In addition, as previously discussed, the organization may contribute credits to a scholarship fund that all, or a portion thereof, may be randomly allocated to one or more beneficiaries, in order to provide an additional incentive for users to establish an account and/or participate in the residual benefit program by purchasing qualifying products and/or services.

The previous description of the disclosed examples is provided to enable any person of ordinary skill in the art to make or use the disclosed methods and apparatus. Accordingly, the terminology employed throughout should be read in a non-limiting manner. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and/or methods.

What is claimed is:

1. A method of providing a residual benefit for a purchase comprising:
determining an account for receiving the residual benefit;
receiving a code associated with the purchase;
depositing a first credit in the account based upon the receipt of the code;
depositing a second credit in the account based on an investment of the first credit;
determining a redeemer to provide the residual benefit; and
transferring the first credit and the second credit to the redeemer for the provision of the residual benefit.

2. The method of claim 1 further comprising establishing the account for receiving the residual benefit.

3. The method of claim 2 wherein the establishing of the account for receiving the residual benefit is done via a webpage or a software application.

4. The method of claim 2 further comprising depositing a third credit in the account based upon receipt of a product at a recycling center.

5. The method of claim 2 further comprising:
establishing a scholarship find; and
depositing at least a portion of the scholarship fund into the account if the account is chosen by random among a plurality of accounts established for receiving residual benefits.

6. The method of claim 1 wherein the determining of the account for receiving the residual benefit and the determining of the institution to provide the residual benefit is based upon input received via a webpage or a software application.

7. The method of claim 1 further comprising establishing a category associated with a first plurality of redeemers, wherein the first plurality of redeemers are selected amongst for determining the redeemer to provide the residual benefit.

8. The method of claim 7 wherein a second plurality of redeemers not associated with the category cannot be determined to be the redeemer to provide the residual benefit.

9. The method of claim 8 wherein the category is one of education, athletics, music, entertainment, charity, travel, technology, food, or clothing.

10. A residual rewards program system comprising:
a memory configured to store at least one user account; and
a processor coupled with the memory and configured to:
determine one of the at least one user accounts for receiving a residual benefit;
receive a code associated with a purchase;
deposit a first credit in the determined user account based upon the receipt of the code;
deposit a second credit in the determined user account based on an investment of the first credit;
determine a redeemer to provide the residual benefit; and
transfer the first credit and the second credit to the redeemer for the provision of the residual benefit.

11. The system of claim 10 wherein the processor is configured to determine the one of the at least on user accounts based upon user input received from an end-user device.

12. The system of claim 10 wherein the processor is configured to receive the code via user input from a webpage.

13. The system of claim 10 wherein the processor is configured to deposit a third credit in the determined user account based upon receipt of a product at a recycling center.

14. The system of claim 13 wherein the product had a code associated therewith, the code previously having been received by the processor.

15. A method of providing a residual benefit to a beneficiary comprising:
establishing an account for the beneficiary;
depositing an amount of credits in the account for the beneficiary based upon a purchase from a participating partner;
providing a plurality of redeemers to be selected amongst by the beneficiary when the beneficiary chooses to redeem at least a portion of the amount of credits in the account;
determining a selected redeemer from the plurality of redeemers for redemption of at least a portion of the amount of credits in the account; and
transferring the at least a portion of the amount of credits in the account to the selected redeemer.

16. The method of claim 15 wherein the plurality of redeemers are organized into categories.

17. The method of claim 16 wherein the categories include at least one of the following: education, athletics, music, entertainment, charity, travel, technology, food, retail, real estate, new business ventures, financial services, or clothing.

18. The method of claim 16 wherein redeemers of a first category are provided to be selected amongst by the beneficiary and wherein redeemers of a second category are not provided to be selected amongst by the beneficiary.

19. The method of claim 18 further comprising determining the first category or the second category based upon input from an end user.

20. The method of claim 15, further comprising:
receiving a product at a recycling center; and
depositing recycle credits in the account for the beneficiary.

21. A method of providing a residual benefit to a beneficiary comprising:
establishing an account for the beneficiary;
depositing an amount of credits in the account for the beneficiary based upon a purchase from a participating partner;
growing the amount of credits in the account over time;
determining a redeemer for providing a good or service to the beneficiary; and
transferring at least a portion of the amount of credits in the account to the redeemer.
